(19) United States
(12) Patent Application Publication
(10) Pub. No.: US 2016/0265974 A1
(43) Pub. Date: Sep. 15, 2016

(54) GLASS WAVEGUIDE SPECTROPHOTOMETER

(71) Applicant: Corning Incorporated, Corning, NY (US)

(72) Inventors: John Phillip Ertel, Half Moon Bay, CA (US); Jeffrey Stapleton King, Menlo Park, CA (US)

(21) Appl. No.: 14/641,912

(22) Filed: Mar. 9, 2015

(51) Int. Cl. G01J 3/427; G01J 3/18; G01J 3/26

(52) U.S. Cl. CPC G01J 3/427; G01J 3/26; G01J 3/1895

(57) ABSTRACT

A spectrophotometer optics system is provided. The spectrophotometer optics system includes an optical sensing array and an optical waveguide including an input side and an output side. The input side of the optical waveguide receives input light and the optical sensing array is located at the output side of optical waveguide. The optical waveguide is configured to carry light to be analyzed by total internal reflection to the output side of the optical waveguide and to direct the light to be analyzed toward the optical sensing array. The spectrophotometer optics system includes an optical dispersive element configured to separate the light to be analyzed into separate wavelength components, and the optical dispersive element is supported by the optical waveguide.

### BACKGROUND

The disclosure relates generally to the field of spectrophotometry, and specifically to a portable spectrophotometer utilizing a glass waveguide. Generally, a spectrophotometer is a device that measures a property of light, such as intensity of light at one or more wavelength, that has interacted with an analyte for example through transmission or reflection. The measured property of the light that interacts with the analyte is then correlated to a property of the analyte (e.g., concentration of a particular material) such that the property of the analyte may be measured. More generally, a spectrophotometer measures the intensity at a range of discrete wavelengths of a light source. For example a spectrophotometer can be used to characterize the emission spectrum of a photoluminescent material.

### SUMMARY

One embodiment of the disclosure relates to a spectrophotometer optics system. The spectrophotometer optics system includes an optical sensing array configured to generate signals related to the intensity of light to be analyzed that interacts with the array. The spectrophotometer optics system includes an optical waveguide including an input side and an output side. The input side of the optical waveguide receives input light and the optical sensing array is located at the output side of optical waveguide. The optical waveguide is configured to carry light to be analyzed by total internal reflection to the output side of the optical waveguide and to direct the light to be analyzed toward the optical sensing array. The spectrophotometer optics system includes an optical dispersive element configured to separate the light to be analyzed into separate wavelength components, and the optical dispersive element is supported by the optical waveguide.

An additional embodiment of the disclosure relates to an optics arrangement for a spectrophotometer. The optics arrangement for a spectrophotometer includes an optical detector and an optical dispersive element configured to separate light to be analyzed into separate wavelength components. The optics arrangement for a spectrophotometer includes a sheet of glass having an input side and an output side. The sheet of glass acts as an optical waveguide in which the input side receives input light and the output side directs light to be analyzed onto the optical detector. A path for the light to be analyzed within the sheet of glass includes at least one of a path for the light to be analyzed between an analyte and the optical detector and a path for the light to be analyzed between the optical dispersive element and the optical detector.

An additional embodiment of the disclosure relates to a portable spectrophotometer device configured to interface with a portable computing device. The portable spectrophotometer device includes an interface device configured to couple the portable spectrophotometer device to the portable computing device. The portable spectrophotometer device includes a spectrophotometer optics system. The spectrophotometer optics system includes a light source, a sample support area configured to support an analyte and an optical dispersive element configured to separate light into separate wavelength components. The spectrophotometer optics system is configured to direct light from the light source to interact with the analyte, to pass through the optical dispersive element and to direct the light onto an optical sensor array. The spectrophotometer optics system includes a housing supporting the interface device and the spectrophotometer optics system.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 shows an exploded view of a glass waveguide spectrophotometer according to an exemplary embodiment.

FIG. 2 is a detailed side view of the glass waveguide spectrophotometer of FIG. 1 according to an exemplary embodiment.

FIG. 3 is a detailed side view of a glass waveguide spectrophotometer according to another exemplary embodiment.

FIG. 4 is a detailed side view of a glass waveguide spectrophotometer according to another exemplary embodiment.

FIG. 5 is a detailed side view of a glass waveguide spectrophotometer according to another exemplary embodiment.

FIG. 6 is a detailed side view of a glass waveguide spectrophotometer according to another exemplary embodiment.

FIG. 7 is a detailed side view of a glass waveguide spectrophotometer according to another exemplary embodiment

FIG. 8 shows a portable computing device including a glass waveguide spectrophotometer according to an exemplary embodiment.

FIG. 9 shows a portable computing device including a glass waveguide spectrophotometer according to another exemplary embodiment.

FIG. 10 is a rear perspective view of a portable computing device including a spectrophotometer optics system according to another exemplary embodiment.

FIG. 11 is a front perspective view of the portable computing device including a spectrophotometer optics system of FIG. 10 according to an exemplary embodiment.

FIG. 12 shows the resolution of a linear variable filter at select wavelengths according to an exemplary embodiment.

### DETAILED DESCRIPTION

Referring generally to the figures, various embodiments of a spectrophotometer that utilizes a glass waveguide as part of its optics system are shown. In addition, various embodiments of a compact spectrophotometer configured for use with a portable computing device are shown. In various embodiments, one or more of the optical elements of a spectrophotometer are embedded or incorporated into a glass waveguide. In some embodiments, use of the waveguide allows for a relatively compact optical component or device that could be used with or incorporated for use with a portable computing device.

In some embodiments, the optical waveguide may be a glass sheet, such as a sheet of glass protecting a display device of a smartphone, tablet, smartwatch, smartglasses, laptop, etc. In various embodiments, a light dispersive element, which separates out different spectral components of light, is attached, embedded or otherwise manufactured onto or in the glass waveguide. Further, the optical sensing device (e.g., CCD, photodiode array, etc.) may be incorporated into close proximity with the waveguide further contributing to the compact nature of the device. In some embodiments, the spectrophotometer device may be configured to analyze external light sources, and in other embodiments, the spectrophotometer device may include a sensing area for holding or supporting the material to be analyzed (e.g., an analyte).

In various embodiments, the spectrophotometers discussed herein utilize one or more native component of a portable computing device. In some such embodiments, the spectrophotometer may utilize a light source, such a camera flash, a digital camera sensor array and/or the processing circuit of the portable computing device. In addition, the use of certain components discussed herein, such as glass waveguides and/or linear variable filters, may allow for a relatively thin spectrophotometer optics arrangement suitable for convenient deployment in conjunction with portable computing platforms. In various embodiments, the compact spectrophotometer embodiments discussed herein may find uses in the areas of scientific instruments, health care, personal health monitoring, environmental monitoring, as well as industrial applications in industries such as chemical, pharmaceutical and food and beverage.

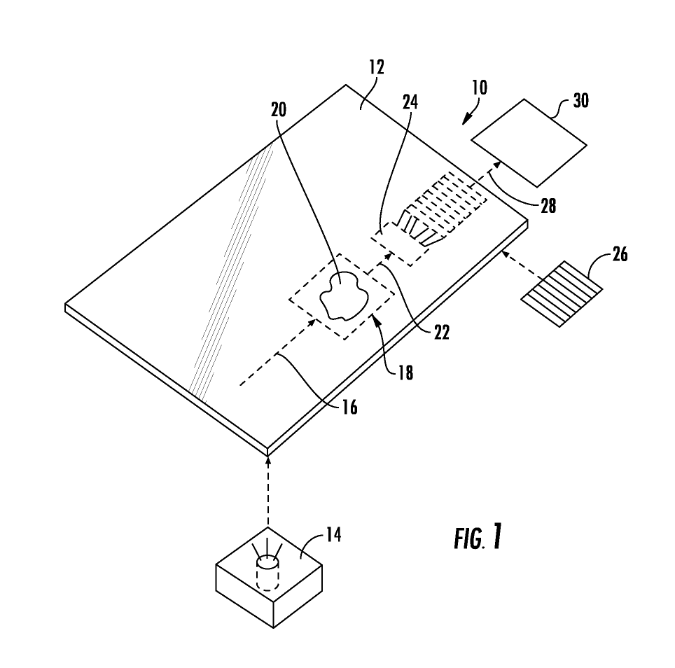

Referring to FIG. 1, a spectrophotometer optics system or spectrophotometer optics arrangement, shown as a waveguide based spectrophotometer 10, is shown according to an exemplary embodiment. Spectrophotometer 10 includes a glass waveguide, shown as glass sheet 12. As described in more detail below, glass sheet 12 acts as a pathway to direct and contain light traveling between the various components of spectrophotometer 10.

Spectrophotometer 10 includes a light source 14 that directs light, shown graphically as the arrow labeled 16, into glass sheet 12. In various embodiments, light source 14 may be a broad spectrum light source, such as a white light LED, and in other embodiments, light source 14 may be a narrow spectrum light source generating a particular spectrum of light to be used for a particular application. In FIG. 1 light source 14 is shown spaced from glass sheet 12 to better show the components of spectrophotometer 10, but in an exemplary embodiment, light source 14 closely abuts or contacts glass sheet 12 to increase the portion of light generated by light source 14 that is received into glass sheet 12.

In the embodiment shown, spectrophotometer 10 includes a sensing area 18 that can support or otherwise come into contact with a material to be analyzed, shown as analyte 20. Light 16 interacts with analyte 20 generating light to be analyzed, shown graphically by the arrow labeled 22. In the embodiment of FIG. 1, light to be analyzed 22 interacts with an optical dispersive element, shown as embedded grating 24, that is supported by glass sheet 12. In general, grating 24 separates light to be analyzed 22 into separate wavelength components, and directs light onto an optical sensing array, such as charge coupled device (CCD) 26. In FIG. 1, CCD 26 is shown spaced from glass sheet 12 to clearly show CCD 26. However, positioning of CCD 26 adjacent glass sheet 12 is indicated by the broken line representation of CCD 26 downstream from grating 24. It should be understood that in various embodiments, the optical sensing device of spectrophotometer 10 may include any suitable optical sensing device, include CCDs and photodiode arrays. In one embodiment, CCD 26 includes a linear array of photosensitive elements arranged as shown in FIG. 1. In another embodiment, CCD 26 includes a two dimensional array or grid of photosensitive elements positioned to analyze light dispersion in at least two planes (e.g., the vertical and horizontal planes).

In various embodiments, grating 24 is a diffraction grating, and in specific embodiments, grating 24 is a chirped grating. In general, CCD 26 generates signals, such as electronic signals 28, related to the intensity of the different wavelength components of the light to be analyzed that interact with different portions of CCD 26. In various embodiments, the optical sensing devices used by the spectrophotometer embodiments discussed herein may be configured or optimized to detect the relevant portions of the spectrum of light to be analyzed 22. As will generally be understood, signals 28 may be received and processed by a processing circuit, such as processor 30. In various embodiments, processor 30 may be a processor of a portable general purpose computing device, such as a smartphone, tablet, smartwatch, smartglasses, laptop, etc. In other embodiments, processor 30 may be the processor of a dedicated spectrophotometer processing device.

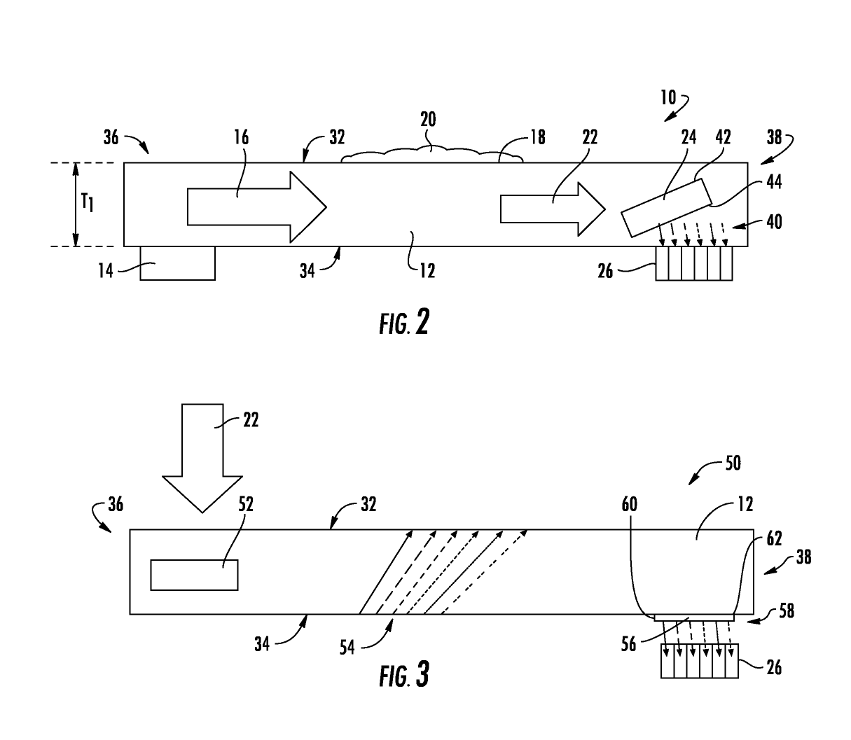

Referring to FIG. 2, a side view of spectrophotometer 10 is shown according to an exemplary embodiment. Glass sheet 12 includes a first major surface, shown as upper surface 32, and a second major surface, shown as lower surface 34. Glass sheet 12 includes a thickness, T1, between upper surface 32 and lower surface 34. In various embodiments, T1 is between 20 micrometers and 2 millimeters.

In the embodiment shown, light source 14 is in contact with lower surface 34 such that light 16 is allowed to efficiently enter glass sheet 12. Sensing area 18 is an area along upper surface 32 such that analyte 20 is supported on upper surface 32. In the embodiment shown, CCD 26 is located along lower surface 34 such that light is able to exit glass sheet 12 to interact with CCD 26.

As noted above, glass sheet 12 acts as an optical waveguide such that light is carried between the different components of spectrophotometer 10 via total internal reflection. Accordingly, in the exemplary arrangement of FIG. 2, glass sheet 12 has an input side 36 and an output side 38. Light source 14 is located at input side 36 of glass sheet 12, and CCD 26 is located at output side 38 of glass sheet 12. Thus, in this arrangement, glass sheet 12 acts as a waveguide carrying light 16 within glass sheet 12 from input side 36 to sensing area 18. At sensing area 18, light 16 within glass sheet 12 interacts with analyte 20 on upper surface 32 (e.g., via evanescent light interaction, via optical coupling due to index matching, critical angle change when analyte 20 is a liquid, absorption and photoluminescence, etc.) generating light to be analyzed 22. Glass sheet 12 also acts as a waveguide directing light to be analyzed 22 toward grating 24, and following dispersion created by grating 24, the wavelength separated light to be analyzed 40 is carried to output side 38 where the light interacts with CCD 26.

Because glass sheet 12 acts as an optical waveguide, the light within glass sheet 12 is carried by total internal reflection from input side 36 to output side 38. Thus, in this embodiment, the light of spectrophotometer 10 is transmitted completely within glass sheet 12 from input side 36 to output side 38. Thus, in such embodiments, at least one of light 16 traveling between the light source and the analyte, light to be analyzed 22 traveling between the analyte and the optical detector, and/or light traveling between the optical dispersive element and the optical detector is carried within the optical waveguide.

While FIG. 1 shows an embodiment in which the input light interacts with analyte 20 while within glass sheet 12, in other various embodiments, incoming light 16 may have interacted with the desired analyte outside of glass sheet 12, and thus, in this embodiment, light 16 is the light to be analyzed. In other embodiments, spectrophotometer 10 may be a colorimeter in which incoming light 16 from a light source is going to be analyzed. In such embodiments, glass sheet 12 acts as a waveguide directing the light to be analyzed from input side 36, through grating 24 and onto CCD 26.

Further, in various embodiments, the light within glass sheet 12, represented by arrows labeled 16 and 22, is nonseparated light (broadband light) that includes multiple wavelength components that are not spatially separated from each other. In addition in, such embodiments, the light with glass sheet 12 includes light traveling at multiple angles of incidence relative to the major surfaces of glass sheet 12, such that the waveguide is “filled” with light. In various embodiments, glass sheet 12 supports transmission of light within glass sheet 12 for all angles with respect to the surface normal above the critical angle, which is roughly 42 degrees for a glass-air interface. Thus, in such embodiments, the manner in which light is carried within glass sheet 12 of spectrophotometer 10 is different from systems in which columnar or single mode light is provided into a waveguide.

As noted above, spectrophotometer 10 includes a dispersive element, such as grating 24, embedded within glass sheet 12. As shown in FIG. 2, grating 24 is structured and positioned within glass sheet 12 such that wavelength separated light 40 is generated from nonseparated (broadband) light 22. Further, grating 24 is structured and positioned within glass sheet 12 such that the separated wavelengths are directed on to separate sections (e.g., pixels) of CCD 26. In various embodiments, grating 24 is positioned to spatially separate light in the direction of the z-axis (in the orientation of FIG. 1), and in some various embodiments, grating 24 is positioned to spatially separate light in the direction perpendicular to the surfaces 32 and 34. In specific embodiments, grating 24 is positioned to spatially separate light in at least two directions (e.g., in the direction of the z-axis in the orientation of FIG. 1 and in the direction of the long axis of sheet 12). In some embodiments, grating 24 is a chirped grating to vary the wavelength from the leading edge to the trailing edge. In various embodiments, an optical dispersive element, such as grating 24, can be written into the glass material of glass sheet 12 via techniques such as laser writing, and in other embodiments, the surface of glass sheet 12 can be patterned via embossing, micron-scale machining, photolithography, or other similar approaches. More complicated structures could be formed by laser writing waveguides to route light within glass sheet 12.

In various embodiments, nonseparated light to be analyzed 22 is directed by glass sheet 12 onto input side 42 of grating 24. Nonseparated light to be analyzed 22 includes multiple wavelength components and also includes light traveling at a variety of angles of incidence relative to the major surfaces of glass sheet 12. Grating 24 separates the wavelength components of light 22 and transmits separated light 40 at different angles within glass sheet 12 toward CCD 26 such that the different wavelength components of light 40 at different angles interacts with different appropriate array sectors of CCD 26. In one embodiment, As shown in FIG. 2, light 40 leaves output side 44 of grating 24 and is directed toward CCD 26.

In various embodiments, glass sheet 12 may be formed from a wide variety of suitable glass materials capable of functioning as a waveguide. In various embodiments, glass sheet 12 may be formed from a fusion drawn glass material, and in specific embodiments, glass sheet 12 may be EagleXG glass, Gorilla Glass, high purity fused silica (HPFS), or Iris Glass available from Corning, Inc. It is believed that a fusion drawn glass material provides a desirable waveguide for this application because of properties including low volume defects, uniformity, low absorption, pristine surfaces, etc. In some embodiments, glass sheet 12 is a low-Fe form of fusion drawn glass, such as that disclosed in US Published Patent Application 2014/0152914A1, which is incorporated herein by reference in its entirety.

In various embodiments, glass sheet 12 may be formed in a wide range of sizes as desired for certain applications. In various embodiments, the width and/or height of glass sheet 12 may between 10 millimeters and 100 centimeters. In some embodiments, a subsection of glass sheet 12 may be utilized as the waveguide for spectrophotometer 10, and in other embodiments, the entirety of glass sheet 12 may be used as the waveguide for spectrophotometer 10.

In various embodiments, spectrophotometer 10 may be configured to utilize light at any wavelength useful for any spectrophotometry. In such embodiments, spectrophotometer 10 is configured to allow light at the desired wavelengths to be carried within glass sheet 12. CCD 26 is configured to generate electrical signals in response to interaction with light at the desired wavelengths, and grating 24 is configured to separate light into different wavelength components within the range of the desired wavelengths. In various embodiments, spectrophotometer 10 is configured to utilize light in the visible, infrared, near infrared and ultraviolet spectrums. In various embodiments, spectrophotometer 10 is configured to utilize light having wavelengths between 10 nanometers and 1 mm. In specific embodiments, spectrophotometer 10 is configured to utilize light having wavelengths between 100 nanometers and 20 microns. In specific embodiments, glass sheet 12 is an HPFS glass sheet that has an upper wavelength cutoff around 150 nm. In other specific embodiments, glass sheet 12 is an SiO2 based glass sheet that has an upper wavelength cutoff around 2.5 microns. In other specific embodiments, glass sheet 12 is Chalcogenide glass that has an upper wavelength cutoff range between 10 and 20 microns.

Referring to FIG. 3, another embodiment of a waveguide based spectrophotometer, shown as spectrophotometer 50, is shown according to an exemplary embodiment. Spectrophotometer 50 is substantially the same as spectrophotometer 10 except as discussed herein. Spectrophotometer 50 includes an embedded grating 52 generally located at the input side 36 of glass sheet 12. Light to be analyzed 22 enters input side 36 of glass sheet 12 and interacts with embedded grating 52. Embedded grating 52 disperses incoming light to be analyzed 22 to different propagation angles corresponding to different wavelengths of light. Dispersed light 54 travels through glass sheet 12 toward output side 38. In one embodiment, light to be analyzed 22 has interacted with an analyte (e.g., an analyte in a cuvette) prior to entering glass sheet 12. In another embodiment, light to be analyzed 22 may be light generated from a light source, reflected from a material or ambient light, and spectrophotometer 50 determines the spectrum of the light, and in a specific embodiment, spectrophotometer 50 operates as a colorimeter.

Spectrophotometer 50 includes a spatial separation device, shown as variable index film 56, that is configured to spatially separate the wavelength components of light 54 generating spatially separated light 58. Variable index film 56 is positioned between output side 38 of glass sheet 12 and CCD 26 such that different spatially separated wavelength components of light are directed toward spatially distinct sections or portions of CCD 26. As will be understood, variable index film 56 allows for analysis of the resulting spectrum due to a gradually changing critical angle from the leading edge 60 to the rear edge 62 of the film. In various embodiments, the index varies from low to high index, eventually matching the index of the waveguide. In this embodiment, because grating 52 acts to disperse light prior to interacting with variable index film 56, variable index film 56 does not have to affect the propagation angles of the already dispersed light.

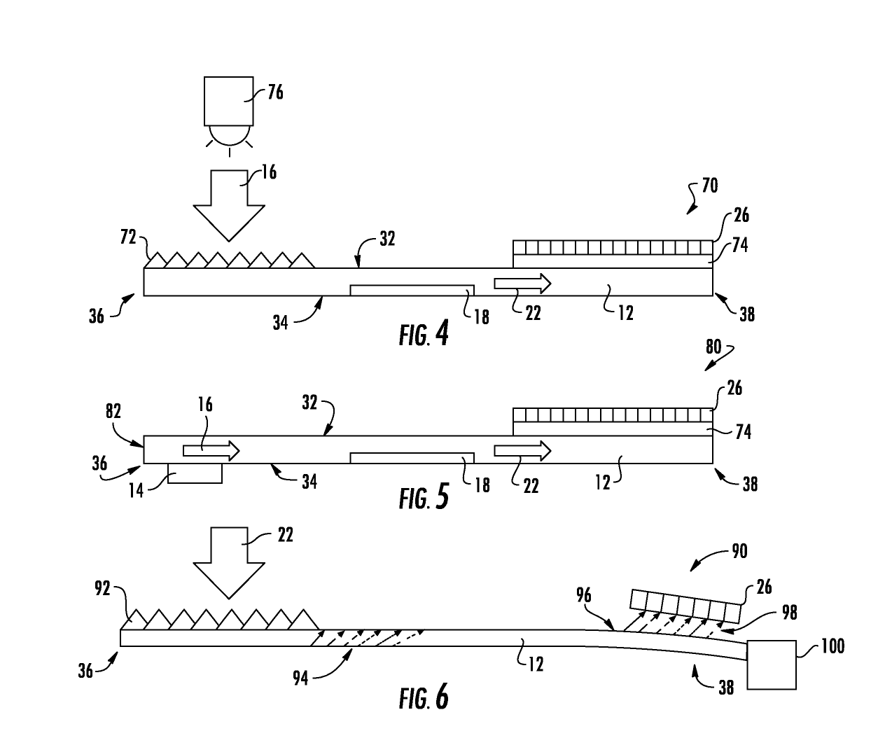

Referring to FIG. 4, another embodiment of a waveguide based spectrophotometer, shown as spectrophotometer 70, is shown according to an exemplary embodiment. Spectrophotometer 70 is substantially the same as spectrophotometer 10 except as discussed herein. Spectrophotometer 70 includes an optical input coupler 72 located at input side 36 of glass sheet 12. Optical input coupler 72 may include one or more prism, scattering feature, lens, etc. that directs input light 16 from an external light source 76 into glass sheet 12. Light 16 will interact with an analyte located at sensing area 18 to generate light to be analyzed 22.

Spectrophotometer 70 includes an optical dispersive element, shown as linear variable filter (LVF) 74, located between glass sheet 12 and CCD 26. In this embodiment, LVF 74 is mounted or formed onto one of the surfaces of glass sheet 12 at a position to direct light onto CCD 26. In this embodiment, light 22 within glass sheet is non-normal incidence. Further, in this embodiment, LVF 74 acts both as a dispersive element separating light 22 into separate wavelength components and also to spatially separate light 22 in order to direct the separate wavelength components onto spatially distinct portions of CCD 26.

Referring to FIG. 5, another embodiment of a waveguide based spectrophotometer, shown as spectrophotometer 80, is shown according to an exemplary embodiment. Spectrophotometer 80 is substantially the same as spectrophotometer 70 except as discussed herein. Specifically, spectrophotometer 80 includes a light source 14 optically coupled to one of the major surfaces of glass sheet 12 instead of external light source 76. In another embodiment, light source 14 may be coupled to one of the minor surfaces or edge surfaces 82 of glass sheet 12. In various embodiments, light source 14 could be a white LED, for broadband measurements, or in other embodiments, light source 14 could be a specific wavelength LED chosen for specific applications, such as photoluminescence.

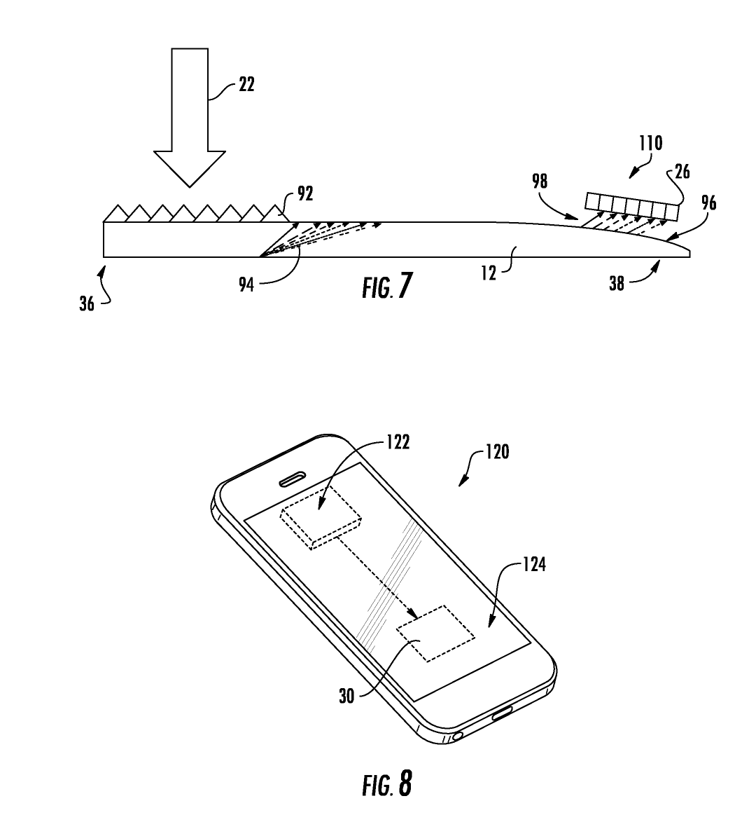

Referring to FIG. 6, another embodiment of a waveguide based spectrophotometer, shown as spectrophotometer 90, is shown according to an exemplary embodiment.

Spectrophotometer 90 is substantially the same as spectrophotometer 10 except as discussed herein. Spectrophotometer 90 includes a dispersive input coupler 92 located at input side 36. Light to be analyzed 22 enters input side 36 of glass sheet 12 through dispersive input coupler 92. Dispersive input coupler 92 disperses incoming light to be analyzed 22 to different propagation angles corresponding to different wavelengths of light, shown as dispersed light 94. Dispersed light 94 travels through glass sheet 12 toward output side 38.

Glass sheet 12 includes a curved outer surface section 96 located facing CCD 26. Curved surface 96 has a convex variable bend radius, and the variable bend radius of curved surface 96 will cause separated light 94 to exit glass sheet 12 at different points along the curved surface generating spatially separated output light 98. CCD 26 is positioned relative to curved surface 96 such that spatially separated output light 98 is directed onto spatially distinct sections of CCD 26.

In one embodiment as shown in FIG. 6, glass sheet 12 may be a flexible thin sheet of glass, and an actuator, such as a MEMS actuator 100, is configured to bend glass sheet 12 to varying degrees causing the bend radius of surface 96 to change. In this manner, MEMS actuator 100 allows spectrophotometer 90 to be tunable, such that the separation of output light 98 is adjusted for different sensing applications. In one embodiment, metallization of the curved surface 96 would facilitate positioning CCD 26 adjacent to glass sheet 12. In some embodiments, an advantage of using thin glass for glass sheet 12 is that more “bounces” means smaller area required to “leak” the light out. The thinner sheet of glass material for glass sheet 12 also means that the guided light interacts with the surface more, and thus in a sensing application could yield greater sensitivity. In various embodiments, the thickness of glass sheet 12 is between 10 microns and 300 microns, and more specifically between 20 microns and 200 microns.

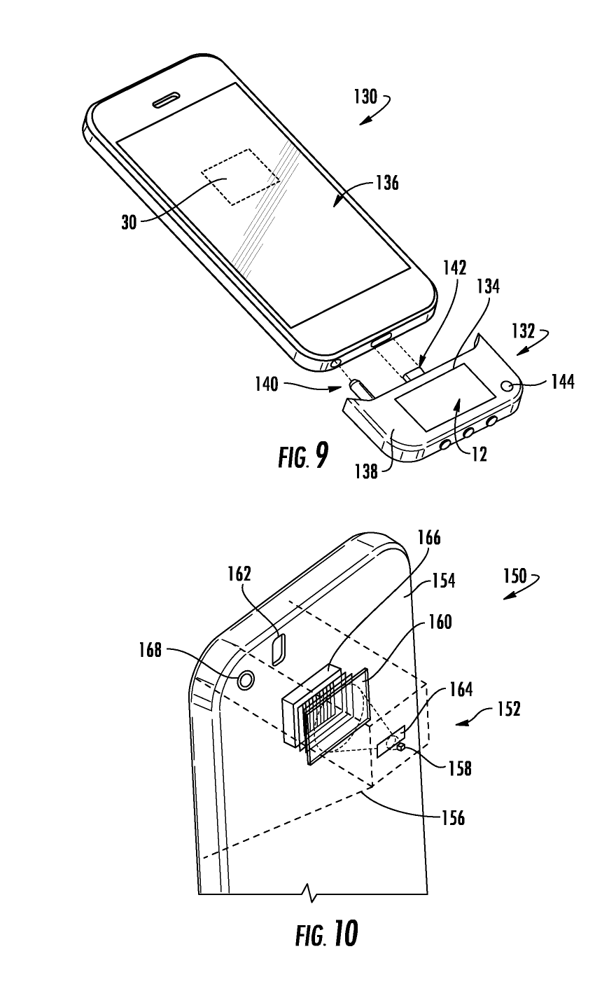

Referring to FIG. 7, another embodiment of a waveguide based spectrophotometer, shown as spectrophotometer 110, is shown according to an exemplary embodiment. Spectrophotometer 110 is substantially the same as spectrophotometer 90 except as discussed herein. In this embodiment, spectrophotometer 110 includes a curved surface 96 is a permanently shaped curved surface rather than one formed by bending. In this embodiment, glass sheet 12 of spectrophotometer 110 is thicker than the glass sheet of spectrophotometer 90. In this embodiment curved surface 96 may be formed by grinding and polishing, and may allow for a greater variety of shapes to be formed in the profile of curved surface 96 as compared to the bendable version shown in FIG. 6.

Referring to FIG. 8, a portable computing device, shown as smartphone 120, is shown according to an exemplary embodiment. Smartphone 120 includes a waveguide-based spectrophotometer, shown as spectrophotometer 122, incorporated into glass sheet 124 that protects the display screen of smartphone 120. In this embodiment, glass sheet 12 of the spectrophotometer may be the entire glass sheet 124 or a portion thereof. Spectrophotometer 122 may be any of the spectrophotometer devices discussed herein. In various embodiments, the optical sensing array, such as CCD 26, of spectrophotometer 122 communicates electrical signals related to the intensity of light at the different wavelengths interacting with the sensor to the processing circuit, shown as processor 30, of smartphone 120. Processor 30 is configured to process, store, and display the processed data as may be desired for different spectrophotometric applications. In various embodiments, a spectrophotometer 122 can be incorporated into any portable computing device, including but not limited to smartwatches, smartglasses, smartphones, tablets, laptops, etc.

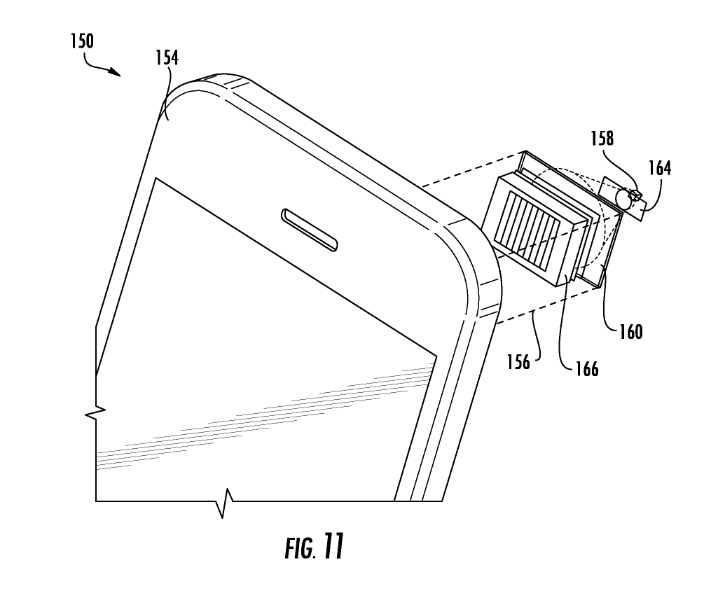

Referring to FIG. 9, in other embodiments, a portable waveguide based spectrophotometer device may be incorporated into a spectrophotometer accessory 132 that is configured to interface with a portable computing device, shown as smartphone 130. In this embodiment, spectrophotometer accessory 132 includes a spectrophotometer 134 which may be any of the spectrophotometer devices discussed herein. In this embodiment, glass sheet 12 is a sheet of glass separate from glass sheet 136 that protects the display screen of smartphone 130. In this embodiment, spectrophotometer accessory 132 includes a that supports the various components of spectrophotometer accessory 132. In various embodiments, spectrophotometer accessory 132 includes a light source (such as light source 14 discussed above), and includes a dedicated power supply, such as a battery, supported by housing 138.

Spectrophotometer accessory 132 includes an interface device 140 that is configured to couple spectrophotometer accessory 132 to smartphone 130. In various embodiments, interface device 140 is configured to communicably couple spectrophotometer accessory 132 to smartphone 130 such that data generated by CCD 26 is communicated to processor 30 and/or is configured to physically couple spectrophotometer accessory 132 to smartphone 130. In the embodiment shown, interface device 140 includes one or more physical data port plugs 142 that are configured to engage corresponding receiving ports of smartphone 130. In general, data port 142 is configured to communicate data from CCD 26 of spectrophotometer accessory 132 to processor 30 of smartphone 130 for processing to generate data related to the spectrum of light interacting with CCD 26. In other embodiments, spectrophotometer accessory 132 may be a standalone unit, and data port 142 may be configured to wirelessly communicate data to smartphone 130 (e.g., via Bluetooth). In some embodiments, interface device 140 includes one or more power ports that deliver power from a battery of smartphone 130 to components of spectrophotometer accessory 132, such as light source 14.

In one embodiment, spectrophotometer accessory 132 includes an optical sensor array (e.g., a photodiode array, CCD 26, etc.) configured to detect infrared light, visible spectrum light and/or UV light. In such embodiments, spectrophotometer accessory 132 may be equipped with a light meter 144, the output of which is used for calibration of the sensing components of spectrophotometer accessory 132. In such embodiments, light meter 144 is configured to detect light levels in the infrared, visible and/or UV light spectra. In some embodiments, light meter 144 lacks the infrared and UV filters typically used on smartphone camera light meters.

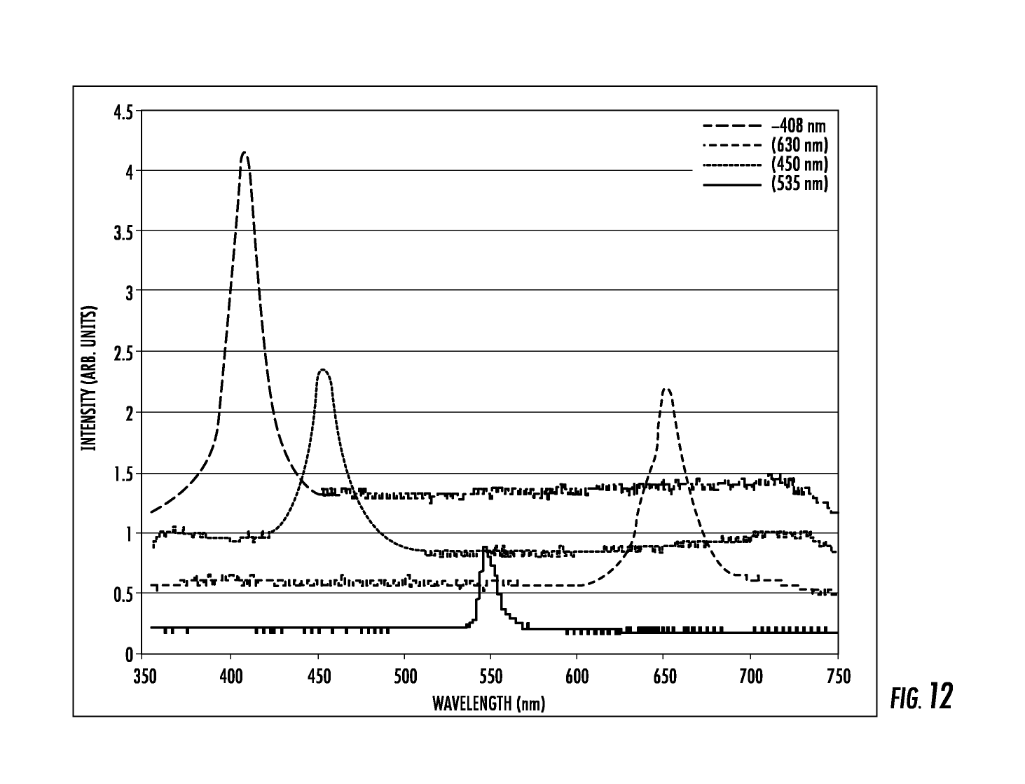

Referring to FIG. 10 and FIG. 11, an exemplary embodiment of portable spectrophotometer device 150 is shown. In general, in this embodiment, spectrophotometer device 150 includes a spectrophotometer optics system 152 configured to couple to a portable computing device, shown as smartphone 154. Spectrophotometer optics system 152 is coupled to smartphone 154 via an interface device, shown in ghost lines as physical support structure 156. In the embodiment shown, physical support structure 156 acts both as a housing supporting the components of spectrophotometer optics system 152, and also as a physical interface device coupling spectrophotometer optics system 152 to smartphone 154.

Spectrophotometer optics system 152 includes a light source, shown as light source 158, and a sample support area 160. In various embodiments, light source 158 may be an LED light source. In some embodiments, spectrophotometer optics system 152 includes a power source, such as a battery supported by physical support structure 156, and in another embodiment, spectrophotometer optics system 152 includes a power connection to a battery of smartphone 154 such that light source 158 is powered by the smartphone battery. In other embodiments, light source 158 may be a mirror configured to reflect light from a camera light 162.

Sample support area 160 is configured to support an analyte in the path of light generated by light source 158. A light diffuser 164 is located between sample support area 160 and light source 158.

In one embodiment, sample support area 160 may be a simple, flat sample plate. In other embodiments, sample support area 160 may be a 10 mm square sample cuvette. Typically, sample cuvettes are made of quartz and have high light transmission in the wavelengths of interest, for example wavelengths between 400 nm and 700 nm. In systems using a cuvette, an empty cuvette (or one filled with a solvent if the sample is dissolved in a solvent) should be placed in the light path during baseline measurements in order to factor out any absorption from the cuvette and solvent.

An optical dispersive element, shown as linear variable filter (LVF) 166, is located between sample support area 160 and an optical sensor array, shown as digital camera sensor 168. In other embodiments, the optical dispersive element of spectrophotometer optics system 152 can be any suitable dispersive element, including one or more prism, diffraction grating, various interference filters, prism film, etc. In other embodiments, the optical dispersive element may be a glass material which is capable of selectively transmitting light according to wavelength such as the so-called “Joseph Glass” materials available from Corning Inc., and according to various embodiments, information related to such materials may be found in Donald S. Stookey et al., Full-color Photosensitive Glass, 49 J. Applied Physics 5114 (1978), which is incorporated herein by reference in its entirety.

, which is incorporated herein by reference in its entirety. In various embodiments, LVF 166 may be an LVF device available from JDS Uniphase Corporation (formerly OCLI), such as LVF400700-3B available from JDS Uniphase Corporation. In other embodiments, LVF 166 may be an LVF device available from Ocean Optics, Inc.

In general, in the arrangement of FIG. 10, physical support structure 156 is configured to engage smartphone 154 and to physically couple spectrophotometer optics system 152 to smartphone 154. In the specific embodiment shown, physical support structure 156 couples spectrophotometer optics system 152 to smartphone 154 such that spectrophotometer optics system 152 is aligned with digital camera sensor 168 of smartphone 154. With spectrophotometer optics system 152 aligned with digital camera sensor 168, light from light source 158 passes through the sample located in sample support area 160 and then pass through optical dispersive element 166 and then onto the digital camera sensor 168. In some embodiments configured for use in conjunction with a digital camera sensor of a smartphone, LVF 166 may have a working wavelength between 400 nm to 700 nm.

In various embodiments, LVF 166 (in contrast to other dispersive elements such as diffraction gratings) provides a relatively compact structure that fits onto a typical smartphone. In specific embodiments, LVF 166 has length between 5 mm and 20 mm and a width between 1 mm and 10 mm. In a specific embodiment, LVF 166 is approximately 12 mm long by 2.7 mm wide and covers a wavelength range of 400 to 700 nm. In some embodiments, LVF 166 also includes a UV, IR and/or higher order wavelength filters in the stack. In these embodiments, LVF 166 is a discrete component support by support structure 156, but in an alternate embodiment, LVF functionality may be directly incorporated into a cover glass or other glass plate (such as glass sheet 12).

Linear variable filter 166 both separates light coming from sample support area 160 into different wavelength components and also spatially separates the light so that different wavelength components are directed to different areas of digital camera sensor 168. Digital camera sensor 168 generates electrical signals related to the spectrum of light interacting with digital camera sensor 168, and these signals are communicated to and processed by the processing circuit of smartphone 154. In various embodiments, digital camera sensor 168 is a high resolution camera (e.g., a 6 megapixel or higher sensor).

In various embodiments, support structure 156 is configured to maintain constant spacing between LVF 166 and digital camera sensor 168. This constant spacing acts to maintain a constant image size of LVF 166 at the digital camera sensor 168 and with the corresponding wavelength scale. In additional embodiments, support structure 156 also includes one or more wall or shield structure that limits the amount of stray light interacting with digital camera sensor 168 during a spectrophotometer reading.

In various embodiments, smartphone 154 is programmed with suitable software to process the data received from digital camera sensor 168 in order to provide spectral analysis of the light that has interacted with the analyte at sample support area 160. In specific embodiments, the image analysis software of smartphone 154 is able to interpret and display the pattern of light interacting with digital camera sensor 168 as a spectrum. In such embodiments, a spectrum of the attenuated light source is used as a reference. The received spectrum of the light that has interacted with sample contained in sample support area 160 is subtracted from the normalized reference spectrum in order to determine the characteristic absorbance of the sample.

In various embodiments, the spectrophotometry software of smartphone 154 is configured to scale the data received from digital camera sensor 168 to establish wavelengths corresponding to position along the length of the filter. In a specific implementation, discrete wavelength light sources near the short and long wavelength extremes of the range could be initially used as a reference to compensate for apparent size of the LVF based on distance from the sensor and camera lens magnification. Once the wavelength scale is established, the light intensity as a function of wavelength (along the length of the filter) is recorded as a baseline for subsequent sample measurements.

For transmission mode operation, after the wavelength scale and baseline intensity is established as described above, a sample is placed within sample support area 160 in the light path between light source 158 and LVF 166. The light passing through the sample will have attenuated intensity as a function of wavelength that is characteristic of the sample based on its absorption of light of specific wavelengths. The light is sensed by the digital camera sensor 168 and is processed by software on smartphone 154 to compare the sample intensity versus wavelength to that of the stored baseline intensity. The results can be saved in memory and displayed as a spectrum of light intensity (representing transmission) as a function of wavelength on the display of the smartphone.

An alternative embodiment would operate in reflective mode, where an LED, preferably already native to the device, such as camera light 162, is used to illuminate a surface of the sample to be analyzed and the reflected light from the sample is analyzed by the spectrophotometer. A further embodiment utilizes an external light source. A further embodiment is used to measure reflected spectra from ambient lights or solar illumination outdoors. In cases of unknown source illumination, a uniform white reflective material (Barium Sulfate or Teflon, for example) can be used to calibrate the sensor. An example application of these modes would be as a colorimeter.

### EXAMPLE

In one example of a LVF based spectrophotometer, a LVF (a JDSU LVF400700-3B LVF) was placed directly on top of a 256 element linear photodiode array (TAOS TSL1402-R-ND) and aligned by hand. The diode array was triggered and powered using an arbitrary waveform generator and the output was read into an oscilloscope. FIG. 12 shows measurements of the LVF resolution made using discrete wavelength light sources (LEDs at the wavelengths shown), and the pixel data from the array was converted to wavelength and scaled to correspond to the sampled wavelengths.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A spectrophotometer optics system comprising:
an optical sensing array configured to generate signals related to the intensity of light to be analyzed that interacts with the array;
an optical waveguide including an input side and an output side, wherein the input side of the optical waveguide receives input light and the optical sensing array is located at the output side of optical waveguide, wherein the optical waveguide is configured to carry light to be analyzed by total internal reflection to the output side of the optical waveguide and to direct the light to be analyzed toward the optical sensing array; and
an optical dispersive element configured to separate the light to be analyzed into separate wavelength components, wherein the optical dispersive element is supported by the optical waveguide.

2. The spectrophotometer optics system of claim 1 wherein the optical waveguide is at least a portion of a sheet of glass having a first major surface, a second major surface opposing the first major surface and a thickness between the first major surface and second major surface, wherein the light to be analyzed travels within the sheet of glass.

3. The spectrophotometer optics system of claim 2 further comprising a sensing area located on the first major surface of the sheet of glass, wherein the input light is carried by the waveguide to interact with an analyte in contact with the first major surface of the glass at the sensing area generating the light to be analyzed, wherein the light to be analyzed is carried by the waveguide from the sensing area to the output side.

4. The spectrophotometer optics system of claim 3 further comprising a light source directing input light into the input side of the waveguide.

5. The spectrophotometer optics system of claim 4 wherein the sheet of glass is a sheet of fusion drawn glass that has a thickness between 20 micrometers and 2 millimeters.

6. The spectrophotometer optics system of claim 5 wherein the sheet of glass is at least a portion of a glass sheet that covers a display screen of a portable computing device, wherein a processing circuit of the portable computing device processes the signals from the optical sensing array to determine the intensity of each of the separate wavelength components of the light to be analyzed that interacts with the optical sensing array.

7. The spectrophotometer optics system of claim 2 wherein the input light is the light to be analyzed, wherein the light to be analyzed is carried by the waveguide from the input side to the output side.

8. The spectrophotometer optics system of claim 1 wherein the optical dispersive element is a diffraction grating embedded within the waveguide.

9. The spectrophotometer optics system of claim 1 wherein the optical dispersive element is a linear variable filter coupled to the optical waveguide located between the output side of the optical waveguide and the optical sensing array.

10. The spectrophotometer optics system of claim 1 further comprising an optical spatial separation device positioned at the output side of the optical waveguide, wherein the spatial separation device spatially separates wavelength components of the light to be analyzed such that the separate wavelength components of the light to be analyzed are directed onto spatially distinct portions of the optical sensing array.

11. The spectrophotometer optics system of claim 10 wherein the spatial separation device is a variable index film positioned between the output side of the optical waveguide and the optical sensing array, wherein the optical dispersive element is positioned relative to the variable index film such that the light to be analyzed passes through the optical dispersive element before passing through the variable index film.

12. The spectrophotometer optics system of claim 10 wherein the spatial separation device is a curved outer surface of the optical waveguide located at the output side of the optical waveguide, wherein the light to be analyzed passes out of the waveguide through the curved outer surface and is directed toward the optical sensing array.

13. An optics arrangement for a spectrophotometer comprising:
an optical detector;
an optical dispersive element configured to separate light to be analyzed into separate wavelength components;
a sheet of glass having an input side and an output side, wherein the sheet of glass acts as an optical waveguide in which the input side receives input light and the output side directs light to be analyzed onto the optical detector;
wherein a path for the light to be analyzed within the sheet of glass includes at least one of:
a path for the light to be analyzed between an analyte and the optical detector; and
a path for the light to be analyzed between the optical dispersive element and the optical detector.

14. The optics arrangement for a spectrophotometer of claim 13 wherein the sheet of glass has an first major surface, a second major surface opposing the first major surface and a thickness between the first major surface and second major surface, wherein the light to be analyzed travels within the sheet of glass.

15. The optics arrangement for a spectrophotometer of claim 14 further comprising a sensing area located on the first major surface of the sheet of glass, wherein the input light is carried within the sheet of glass by total internal reflection to interact with an analyte in contact with the first major surface at the sensing area generating the light to be analyzed, wherein the light to be analyzed is carried within the sheet of glass by total internal reflection from the sensing area to the output side.

16. The optics arrangement for a spectrophotometer of claim 15 wherein the sheet of glass covers a display screen of a portable computing device, wherein a processing circuit of the portable computing device processes data received from the optical detector to determine the intensity of each of the separate wavelength components of the light to be analyzed that interact with the optical detector, wherein the sheet of glass has a thickness between 20 micrometers and 2 millimeters.

17. A portable spectrophotometer device configured to interface with a portable computing device comprising:
an interface device configured to couple the portable spectrophotometer device to the portable computing device;
a spectrophotometer optics system comprising:
a light source;
a sample support area configured to support an analyte;
an optical dispersive element configured to separate light into separate wavelength components, wherein the spectrophotometer optics system is configured to direct light from the light source to interact with the analyte, to pass through the optical dispersive element and to direct the light onto an optical sensor array; and
a housing supporting the interface device and the spectrophotometer optics system.

18. The portable spectrophotometer device of claim 17 wherein the optical sensor array is a digital camera sensor of the portable computing device, wherein the interface device includes a physical support structure configured to physically couple the portable spectrophotometer device to the portable computing device and to align the spectrophotometer optics system relative to the digital camera sensor such that light from the light source passes through the sample area, through the optical dispersive element and then onto the digital camera sensor, wherein a processing circuit of the portable computing device processes electrical signals from the digital camera sensor to generate data related to the spectrum of light interacting with the digital camera sensor.

19. The portable spectrophotometer device of claim 17 wherein the light source is at least one of an LED positioned to direct light through the sample area and a mirror supported by the housing and positioned to reflect light from a camera light source of the portable computing device through the sample area.

20. The portable spectrophotometer device of claim 17 further comprising a light level sensor, wherein the light level sensor is configured to detect the level of light in the visible, infrared and ultraviolet spectra, wherein the optical sensor array is supported by the housing, wherein the interface device includes a data port configured to communicate data from the optical sensor array of the portable spectrophotometer device to the portable computing device, wherein a processing circuit of the portable computing device processes data from the optical sensor array of the portable spectrophotometer device to generate data related to the spectrum of light interacting with the optical sensor array.
